(19) United States
(12) Patent Application Publication
(10) Pub. No.: US 2026/0119348 A1
(43) Pub. Date: Apr. 30, 2026

(54) DYNAMIC FLASH REDUNDANCY FOR FIRMWARE LOADING

(71) Applicant: Intel Corporation, Santa Clara, CA (US)

(72) Inventors: Junyu TONG, Shanghai (CN); Cong ZHANG, Shanghai (CN); Liangqi ZHU, Shanghai (CN); Yonggang PAN, Shanghai (CN); Shaojun YANG, Shanghai (CN)

(21) Appl. No.: 19/432,594

(22) Filed: Dec. 24, 2025

(30) Foreign Application Priority Data
Nov. 7, 2025 (WO) PCT/CN2025/133258

(51) Int. Cl. G06F 11/20; G06F 21/57

(52) U.S. Cl. CPC G06F 11/2017; G06F 21/572; G06F 2201/805; G06F 2221/033

(57) ABSTRACT

Examples described herein relate to a circuitry to: based on detected health data of a first circuit board of multiple circuit boards to load firmware from an associated first storage, cause the first circuit board to load the firmware from a second storage associated with a second circuit board of the multiple circuit boards and based on authentication of the loaded firmware, cause boot operations of the first circuit board using the loaded firmware. In some examples, the circuitry comprises a management controller. In some examples, the health data is based on malfunction of a storage medium of the first storage or malfunction of an interface to the first storage.

### RELATED APPLICATION

This application claims the benefit of priority to PCT/CN2025/133258, filed Nov. 7, 2025. The entire contents of that application are incorporated by reference.

### BACKGROUND

In cloud data centers, enterprise backends, and artificial intelligence (AI) infrastructure, modular multi-socket server architectures are used for scalable, high-availability computing. Modular boards (also referred to as a compute blade or node) include a processor socket, memory, power delivery circuitry, and local firmware storage in the form of a Serial Peripheral Interface (SPI) flash device.

### BRIEF DESCRIPTION OF THE DRAWINGS

FIG. 1 depicts multi-board system.

FIG. 2 depicts dynamic SPI bus multiplexing and proxy boot.

FIG. 3 depicts an example of secure authentication and integrity assurance.

FIG. 4 depicts an example of operations.

FIG. 5 depicts an example process.

FIG. 6 depicts an example system.

### DETAILED DESCRIPTION

Various examples provide a firmware retrieval system and protocol for cross-board SPI flash redundancy and parallel firmware management in modular server architectures. A board with a SPI flash that is inoperative or expected to become inoperative, based on health data, can boot from another board's operating SPI flash, eliminating a single-point-of-failure for boot. Monitoring circuitries can monitor local SPI flash health (e.g., number of Error Correction Coding (ECC) operations, level of medium wear, number of data retrieval faults, or other data) and reports status to a management controller. The management controller can control a multiplexer to route SPI bus signals among boards, with secure handshakes, so that on boot or firmware update, the management controller can cause a board with an inoperative SPI flash to access boot firmware from SPI flash device, not identified as subject to errors or failure, of another board. In other words, a board with a corresponding flash device identified by monitoring circuitry as failed or inoperative can be dynamically assigned to access a flash on another board directly or via proxy. Cross-board accesses can be authenticated and integrity-checked by monitoring circuitries. This architecture is compatible at least with Unified Extensible Firmware Interface (UEFI), Joint Electron Device Engineering Council (JEDEC) standards, Distributed Management Task Force (DMTF) Redfish® standard, and Intelligent Platform Management Interface (IPMI) standards, and can be implemented via firmware updates and explicit hardware modifications to support SPI bus multiplexing and secure protocol execution.

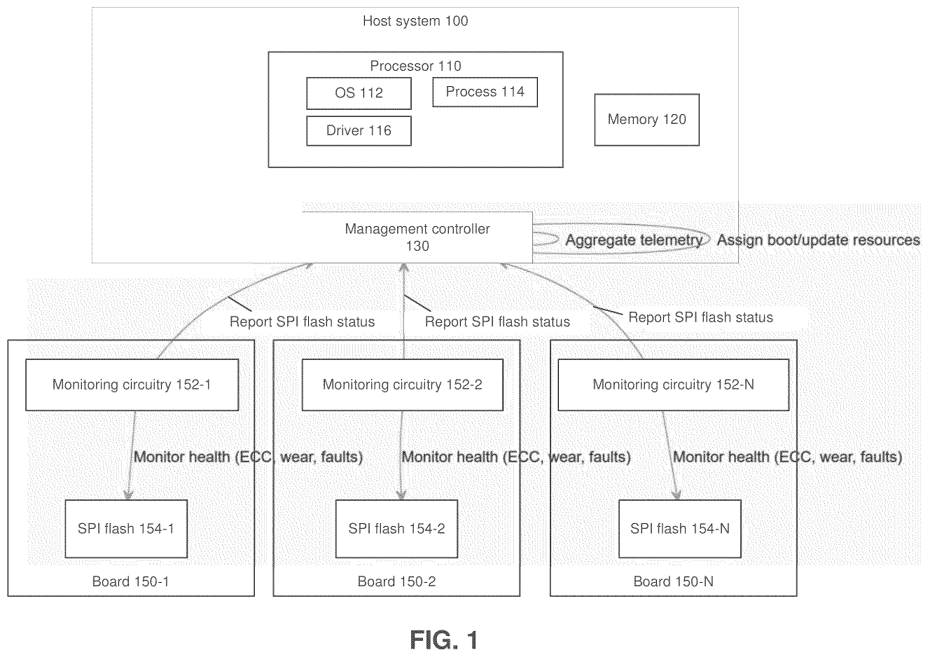

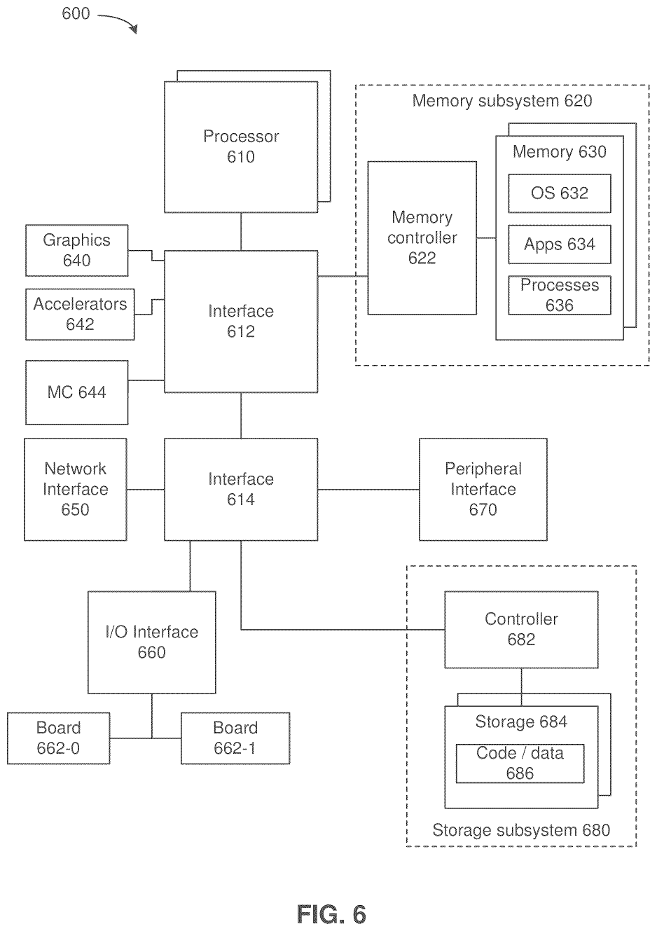

FIG. 1 depicts an example system to monitor SPI flash operations and selectively failover to a SPI flash on another board. Host system 100 can include one or more processors 110, memory 104, management controller 130, and other circuitry and software described at least with respect to FIG. 6. Processors 110 can execute at least one or more of: operating system (OS) 112, processes 114, driver 116, and other software. Processes 114 can include one or more of: an application, process, thread, a virtual machine (VM), microVM, container, microservice, virtual function (VF), virtual device, or other virtualized execution environment. Memory 120 can include one or more registers, volatile memory, non-volatile memory, cache, or other circuitry.

Host system 100 can access boards 150-1 to 150-N, where N is an integer, via midplanes or backplanes, conforming to industry standards such as the Open Compute Project (OCP) Modular Platform, Advanced Telecommunications Computing Architecture (ATCA), or proprietary hyperscale server designs. In a 4 or 8 socket deployment, 4 or 8 physically independent SPI flash devices can be utilized, or one per board. Boards 150-1 to 150-N can connect to a same backplane or midplane, in some examples. A backplane can include a circuit board backbone in a chassis, connecting modules such as storage or expansion cards. A midplane can include a circuit board and can be coupled to a backplane and connect cards on both sides of the midplane.

Processor 110 can access one or more of boards 150-0 to 150-N using device interfaces consistent at least with Peripheral Component Interconnect express (PCIe), Compute Express Link (CXL), or other standards. The PCIe protocol is described in Peripheral Component Interconnect (PCI) Express Base Specification 1.0 (2002), as well as earlier versions, later versions, and variations thereof. The CXL protocol is described in Compute Express Link Specification version 1.0 (2019), as well as earlier versions, later versions, and variations thereof). Processor 110 can access one or more of devices on boards 150-0 to 150-N as Single Root I/O Virtualization (SR-IOV) virtual functions (VFs) or Scalable I/O Virtualization (SIOV) Assignable Device Interfaces (ADIs).

In some examples, boards 150-1 to 150-N can include at least one of: an accelerator, graphics processing unit (GPU), storage device, memory device, network interface device, power delivery circuitry, and Serial Peripheral Interface (SPI) flash devices 154-1 to 154-N. SPI flash devices 154-1 to 154-N can store at least firmware (e.g., Basic Input/Output System (BIOS) or Unified Extensible Firmware Interface (UEFI)), Baseboard Management Controller (BMC) code, microcode updates, and persistent configuration data.

A board can include a circuit board, or Printed Circuit Board (PCB), that includes an insulating non-conductive base (e.g., fiberglass) that mechanically supports and electrically connects electronic components (e.g., chips) using conductive pathways (e.g., copper traces) and pads to which components are soldered to make electrical contact.

Management controller (MC) 130 can include a processor configured to perform monitoring of device temperature, fan speeds, and power status of host system 100 and boards 150-1 to 150-N. Management controller 130 can be configured to respond to remote actions by performance of actions such as power cycling, booting, and resetting devices or circuitry. Management controller 130 can provide management capabilities independent of OS 112, through a dedicated management network port and can support protocols such as Intelligent Platform Management Interface (IPMI) and Redfish. Management controller 130 can provide telemetry and crash data for troubleshooting and proactive maintenance. Management controller 130 can be used to automate the initial setup and firmware updates host system 100 and boards 150-1 to 150-N. In some examples, management controller 130 can be implemented as one or more of: Baseboard Management Controller (BMC), Intel® Management or Manageability Engine (ME), or other devices.

SPI flash devices 154-1 to 154-N are subject to wear-out, program disturb, Error Correction Coding (ECC) failure during read limitations, and board-level interconnect issues (e.g., signal degradation due to aging, temperature, or vibration). An uncorrectable SPI flash error during boot or update can render an entire module and, by extension, host system 100 unbootable. Boards 150-1 to 150-N can include respective monitoring circuitries 152-1 to 152-N. Monitoring circuitries 152-1 to 152-N can monitor health data indicative of operations of SPI flash 154-1 to 154-N (e.g., ECC status, wear-leveling, failure flags as well as interconnect issues) and communicate health data status to management controller 130 over interfaces (e.g., Inter-Integrated Circuit (I2C), System Management Bus (SMBus), or General Purpose Input/Output (GPIO)). As described herein, based on health data indicating reduced capability to load firmware from a SPI flash on a board (e.g., malfunction of the flash medium or malfunction of an interface to the SPI flash), management controller 130 can configure a processor or device on the board to fetch firmware images from a flash of another board to boot or update its firmware.

Management controller 130 can cause parallel firmware updates to operative SPI flashes with operative interfaces. Based on health data from a monitoring circuitry indicating that a SPI flash is inoperative or likely to fail, a board can can have firmware updated via proxy or not updated. Management controller 130 can coordinate SPI bus access and modify scheduling of available system bandwidth for retrieval of firmware by a board from another board.

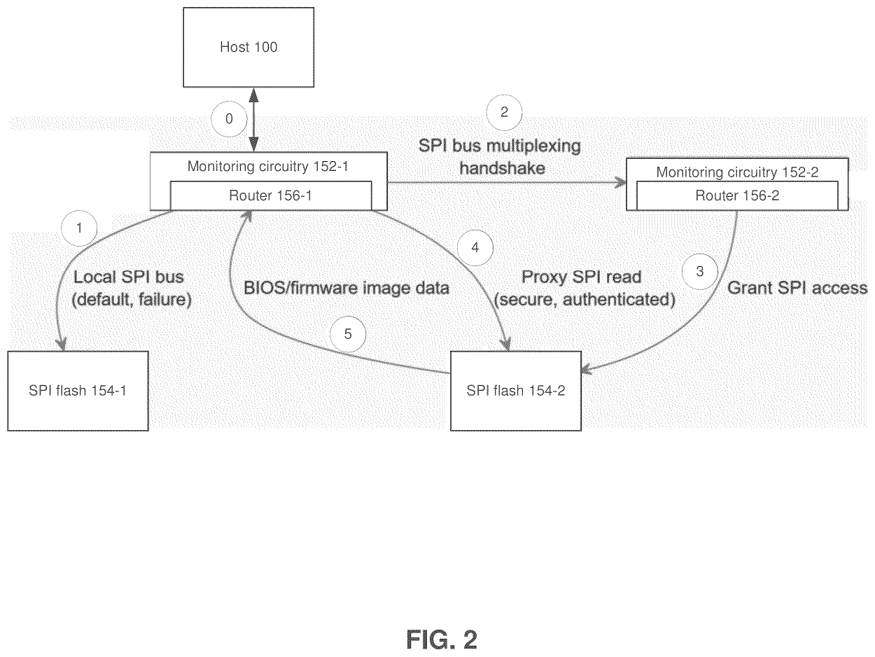

FIG. 2 depicts dynamic SPI bus multiplexing and proxy boot. At (0), host 100 can request operations data of flash 154-1 and 154-2. Although merely two flash devices are shown as monitored, operations of any number of flash can be monitored. However, at (1), based on detected inoperability of flash 154-1 and detected operability of flash 154-2, at (2) management controller 130 can direct monitoring circuitry 152-1 to utilize SPI bus router 156-1 to route SPI flash requests to flash 154-2. Management controller 130 can direct monitoring circuitry 152-2 to permit access by monitoring circuitry 152-1 of firmware or other code in flash 154-2. At (3), monitoring circuitry 152-2 can grant access to SPI flash 154-2 to monitoring circuitry 152-1. At (4), monitoring circuitry 152-1 can issue a request sent as secure (e.g., encrypted) communications and monitoring circuitry 152-2 can authenticate the request. At (5), flash 154-2 can provide the firmware or other code to monitoring circuitry 152-1. At (6), monitoring circuitry 152-1 can route the firmware or other code to flash 154-1. Accordingly, a processor or device board 150-1 can fetch firmware images from flash 154-2 to boot such firmware or update firmware.

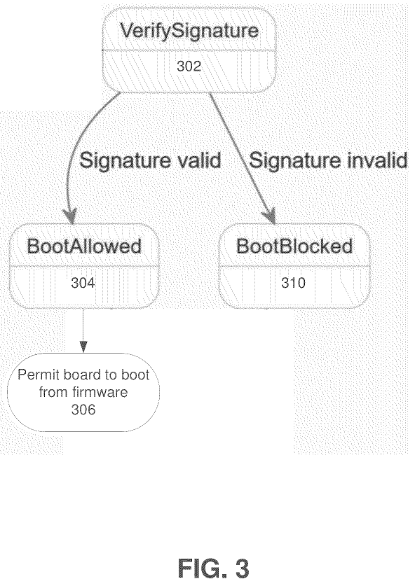

FIG. 3 depicts an example of secure authentication and integrity for requests for firmware. At 302, monitoring circuitry associated with a flash storage can receive a firmware or firmware update from a flash storage of another board and authenticate the firmware or firmware update. For example, a value (e.g., signature or cryptographic hash) received with the firmware or firmware update can be determined to be valid or invalid. Based on the signature or cryptographic hash being valid, at 304, the monitoring circuitry can permit a boot from the received firmware or firmware update at 306. Monitoring circuitry can cryptographically verify proxy reads of firmware from another board before firmware boot proceeds. Based on the signature or cryptographic hash being invalid, at 310, the monitoring circuitry can not permit a boot of the received firmware. Instead, a firmware or firmware update from another board can be loaded or a retry of loading of the firmware or firmware update from the same board can be attempted.

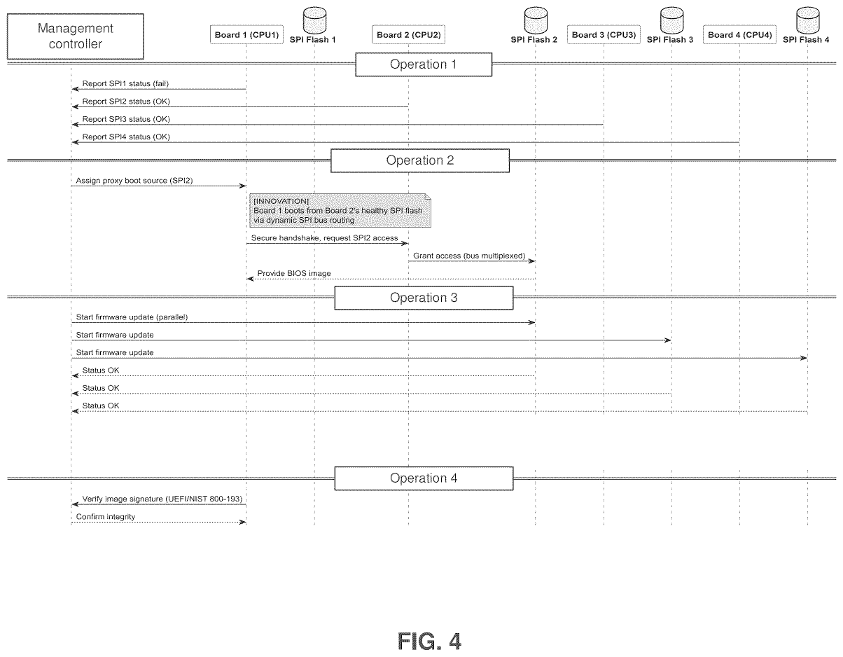

FIG. 4 depicts parallel firmware update. Management controller orchestrates parallel firmware updates to all healthy SPI flashes. Boards with failed flashes can access firmware via proxy or skip booting. Management controller can schedule SPI bus access by utilizing available system bandwidth. At operation (1), management controller can receive status reports from boards 1 to 4. In this example, board 1's SPI flash indicates a fail or lack of proper operation whereas SPI flashes of boards 2-4 report status of okay or operative. At operation (2), the management controller can select a SPI flash of board 2 from boards 2-4 to supply firmware or other code for board 1 so that board 1's processor can boot from board 2's SPI flash. For example, monitoring circuitry of board 1 can perform a cryptographic handshake with monitoring circuitry of board 2 and request access to SPI flash of board 2. Based on granting of access, monitoring circuitry of board 2 can grant monitoring circuitry of board 1 with access to SPI flash of board 2. The SPI flash of board 2 can provide the firmware (e.g., BIOS) to board 1 and based on authentication of the received firmware, board 1 can boot.

At operation (3), the management controller can cause boards 2-4 to load firmware updates. Management controller can receive status updates from SPI flashes of boards 2-4 indicating whether the firmware updates were successfully stored. Thereafter, board 1 can load the firmware update from another board (e.g., board 2).

At operation (4), the management controller can verify the signature of the firmware image utilized by board 1 based at least on UEFI version 2.0 (2006) (or earlier or later versions or variations thereof) or National Institute of Standards and Technology (NIST) 800-193 (2018). For example, the signature can be utilized to sign firmware copied from board 2 to board 1. Based on the signature being valid, board 1 can boot using the firmware from board 2.

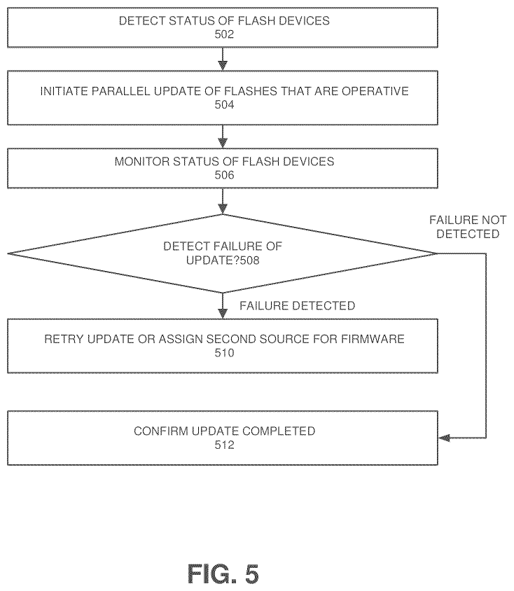

FIG. 5 depicts an example process. At 502, a status of flash devices can be detected. For example, flash device status can indicate whether the flash device is unlikely to deliver firmware or code with errors or unable to output firmware or code such as from defects or wear in the medium or interface to the flash device. At 504, a management controller can cause firmware updates to flash devices that are identified as operative but not to a flash device identified as inoperative. At 506, the management controller can monitor the status of firmware updates to determine if a firmware update failed on a particular device. For example, if a signature of a firmware update is not authenticated or is a deviation from an accepted signature, the firmware update can fail. At 508, based on a failure of a flash device to store a firmware update or receipt of an invalid firmware update, the firmware update can be retried or a proxy update can be attempted by accessing the firmware update from an operating flash device on another board. For example, accessing the firmware update from an operating flash device on another board can include the management controller configuring bus interface bandwidth and connectivity between a board with an inoperative flash device and a board with an operative flash device so that the board with the operative flash device can provide firmware to the board with the inoperative flash device. At 510, based on successful loading of authenticated firmware, the management controller can identify a board as having successfully loaded firmware.

FIG. 6 depicts an example system. As described herein, circuitry of system 600 can detect whether flash storage of a communicatively coupled board is operative or inoperative and selectively cause a board with inoperative flash storage to load firmware from another board, with an operative flash storage, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function field programmable gate arrays (FPGAs)). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Graphics interface 640 can provide an interface to graphics components for providing a visual display to a user of system 600. In one example, graphics interface 640 can drive a display that provides an output to a user. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Management controller 644 can perform management and monitoring capabilities for system administrators or orchestrators to manage and monitor operation of circuitry, firmware, and software of system 600. As described herein, management controller 644 can detect whether flash storage of a communicatively coupled board (e.g., board 662-0) is operative or inoperative and selectively cause a board with inoperative flash storage to load firmware from another board (e.g., board 662-1), with an operative flash storage. Although two boards are shown, any number of boards can be used. Examples of boards 662-0 and 662-1 include one or more of boards 150-0 to 150-N.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory is memory whose state (and therefore the data stored in it) is indeterminate if power is interrupted to the device. A non-volatile memory (NVM) device is a memory whose state is determinate even if power is interrupted to the device.

In an example, system 600 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 600 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

Example 1 includes one or more later examples, and includes an apparatus that includes: a circuitry to: based on detected health data of a first circuit board of multiple circuit boards to load firmware from an associated first storage, cause the first circuit board to load the firmware from a second storage associated with a second circuit board of the multiple circuit boards and based on authentication of the loaded firmware, cause boot operations of the first circuit board using the loaded firmware.

Example 2 includes one or more earlier or later examples, and includes the multiple circuit boards, wherein the multiple circuit boards comprise processors and associated storage devices.

Example 3 includes one or more earlier or later examples, wherein the circuitry comprises a management controller.

Example 4 includes one or more earlier or later examples, wherein: the health data is based on malfunction of a storage medium of the first storage or malfunction of an interface to the first storage.

Example 5 includes one or more earlier or later examples, wherein the health data is based on one or more of: number of data corrections based on error correction code (ECC), storage device wear, number of storage device faults, detected errors in an interface to the first storage.

Example 6 includes one or more earlier or later examples, wherein the first circuit board comprising second circuitry to verify the loaded firmware and authenticate the loaded firmware.

Example 7 includes one or more earlier or later examples, wherein based on failure to authenticate the loaded firmware, the second circuitry is to issue a request to a management controller to re-load the firmware or load the firmware from a third circuit board associated with an operative firmware storage.

Example 8 includes one or more earlier or later examples, wherein the cause the first circuit board to load the firmware from the second storage, circuitry is to schedule and configure bus connections to route the firmware from the second storage to the first circuit board.

Example 9 includes one or more earlier or later examples, and includes a method that includes: based on health data associated with a first storage of a first circuit board, causing a second circuit board to route firmware to the first circuit board and causing the second circuit board to authenticate the firmware prior to execution of the firmware.

Example 10 includes one or more earlier or later examples, and includes based on health data associated with the first storage of the first circuit board, configuring an interface between the first and second circuit boards to copy the firmware from the second circuit board to the first circuit board.

Example 11 includes one or more earlier or later examples, wherein the health data is associated with reduced capability of the first circuit board to load firmware from the associated first storage.

Example 12 includes one or more earlier or later examples, wherein the health data comprises one or more of: storage wear-out, program disturb, number of Error Correction Coding (ECC) corrections, or board-level interconnect issues.

Example 13 includes one or more earlier or later examples, wherein authentication of the firmware comprises verification of a value associated with the firmware and wherein the value comprises a signature or cryptographic hash value.

Example 14 includes one or more earlier or later examples, and includes based on failure to authenticate the firmware, re-loading the firmware or loading the firmware from a third circuit board associated with an operative firmware storage.

Example 15 includes one or more earlier or later examples, and includes at least one non-transitory computer-readable medium comprising instructions stored thereon, that if executed by one or more processors, cause the one or more processors to: configure circuitry of a first circuit board to: report errors in accessing a first flash storage device associated with the first circuit board and selectively load firmware from a second circuit board based on a command from a management controller and authenticate the loaded firmware prior to execution of the loaded firmware.

Example 16 includes one or more earlier or later examples, wherein the command from the management controller to load firmware from the second circuit board is based on error data of the first flash storage device.

Example 17 includes one or more earlier or later examples, wherein the error data comprises one or more of: storage wear-out, program disturb, number of Error Correction Coding (ECC) corrections, or board-level interconnect issues

Example 18 includes one or more earlier examples, wherein the authenticate the loaded firmware comprises verification of a value associated with the firmware and wherein the value comprises a signature or cryptographic hash value.

1. An apparatus comprising:
a circuitry to:
based on detected health data of a first circuit board of multiple circuit boards to load firmware from an associated first storage, cause the first circuit board to load the firmware from a second storage associated with a second circuit board of the multiple circuit boards and
based on authentication of the loaded firmware, cause boot operations of the first circuit board using the loaded firmware.

2. The apparatus of claim 1, comprising the multiple circuit boards, wherein the multiple circuit boards comprise processors and associated storage devices.

3. The apparatus of claim 1, wherein the circuitry comprises a management controller.

4. The apparatus of claim 1, wherein:
the health data is based on malfunction of a storage medium of the first storage or malfunction of an interface to the first storage.

5. The apparatus of claim 4, wherein the health data is based on one or more of: number of data corrections based on error correction code (ECC), storage device wear, number of storage device faults, detected errors in an interface to the first storage.

6. The apparatus of claim 1, wherein the first circuit board comprising second circuitry to verify the loaded firmware and authenticate the loaded firmware.

7. The apparatus of claim 6, wherein based on failure to authenticate the loaded firmware, the second circuitry is to issue a request to a management controller to re-load the firmware or load the firmware from a third circuit board associated with an operative firmware storage.

8. The apparatus of claim 1, wherein the cause the first circuit board to load the firmware from the second storage, circuitry is to schedule and configure bus connections to route the firmware from the second storage to the first circuit board.

9. A method comprising:
based on health data associated with a first storage of a first circuit board, causing a second circuit board to route firmware to the first circuit board and causing the second circuit board to authenticate the firmware prior to execution of the firmware.

10. The method of claim 9, comprising:
based on health data associated with the first storage of the first circuit board, configuring an interface between the first and second circuit boards to copy the firmware from the second circuit board to the first circuit board.

11. The method of claim 9, wherein the health data is associated with reduced capability of the first circuit board to load firmware from the associated first storage.

12. The method of claim 9, wherein the health data comprises one or more of: storage wear-out, program disturb, number of Error Correction Coding (ECC) corrections, or board-level interconnect issues.

13. The method of claim 9, wherein authentication of the firmware comprises verification of a value associated with the firmware and wherein the value comprises a signature or cryptographic hash value.

14. The method of claim 9, comprising:
based on failure to authenticate the firmware, re-loading the firmware or loading the firmware from a third circuit board associated with an operative firmware storage.

15. At least one non-transitory computer-readable medium comprising instructions stored thereon, that if executed by one or more processors, cause the one or more processors to:
configure circuitry of a first circuit board to:
report errors in accessing a first flash storage device associated with the first circuit board and
selectively load firmware from a second circuit board based on a command from a management controller and authenticate the loaded firmware prior to execution of the loaded firmware.

16. The at least one non-transitory computer-readable medium of claim 15, wherein the command from the management controller to load firmware from the second circuit board is based on error data of the first flash storage device.

17. The at least one non-transitory computer-readable medium of claim 16, wherein the error data comprises one or more of: storage wear-out, program disturb, number of Error Correction Coding (ECC) corrections, or board-level interconnect issues.

18. The at least one non-transitory computer-readable medium of claim 15, wherein the authenticate the loaded firmware comprises verification of a value associated with the firmware and wherein the value comprises a signature or cryptographic hash value.
